(19) United States
(12) Patent Application Publication
(10) Pub. No.: US 2017/0136736 A1
(43) Pub. Date: May 18, 2017

(54) Multi-Component Plastic Body

(71) Applicant: Raumedic AG, Munchberg (DE)

(72) Inventors: Philipp Jordan, Bayreuth (DE); Steffen Hager, Helmbrechts (DE); Dominik Erhard, Kulmbach (DE); Rainer Adelung, Kiel (DE); Kristin Mess, Kronshagen (DE); Ingo Paulowicz, Kiel (DE); Fabian Schütt, Kiel (DE)

(21) Appl. No.: 15/350,085

(22) Filed: Nov. 13, 2016

(30) Foreign Application Priority Data
Nov. 13, 2015 (DE) 10 2015 222 396.5

(51) Int. Cl. B32B 7/08; B32B 7/12; B32B 27/08; F16L 11/20; B32B 27/32; B32B 37/12; B32B 37/15; B32B 1/08; B32B 27/28

(52) U.S. Cl. CPC B32B 7/08; B32B 1/08; B32B 7/12; B32B 27/08; B32B 27/283; B32B 27/32; B32B 37/1284; B32B 37/153; F16L 11/20; B32B 2250/02; B32B 2250/24; B32B 2255/10; B32B 2255/26; B32B 2305/08; B32B 2305/72; B32B 2323/10; B32B 2383/00; B32B 2597/00

(57) ABSTRACT

A multi-component plastic body designed as a multi-layered tube has at least one silicone component and at least one further polymer component made of a further nonpolar polymer. A bonding agent between the silicone component and the further polymer component has bonding bodies which mechanically bond the two components to one another. For the production of such a multi-component plastic body, first a base component is produced. The bonding agent is applied thereto, and subsequently a cover component is applied to the base component, such that the bonding agent comes to lie between the silicone component and the further polymer component. The result is a multi-component plastic body having a secure bond between the at least one silicone component and the at least one further polymer component.

### FIELD OF THE INVENTION

The invention relates to a multi-component plastic body having at least one silicone component and one further polymer component.

### BACKGROUND OF RELATED ART

Multi-component plastic bodies of this type are known from the scientific paper by Jin et al., Adv. Mater. 2012, 24, 5676 to 5680, and from DE 10 2008 009 171 B4, DE 10 2010 039 085 A1, and DE 10 2007 044 789 A1.

In U.S. Pat. No. 3,126,311 an adhesive bond is described, made of a polymer component and an additional component, which may be silicone. U.S. 2004/0229043 A1 describes the production of a multi-layered bonding. The production of components made of silicone compounds is known from U.S. 2010/0310805 and WO 2008/109865 A1. WO 2015/010687 A2 describes a polymer laminate and a method for its production.

### SUMMARY OF THE INVENTION

One object of the present invention is to create a multi-component plastic body, with which a secure bond is ensured between at least one silicone component and at least one additional polymer component made of a nonpolar polymer.

This object is achieved according to the invention by a multi-component plastic body having the features given in claim 1.

In accordance with the invention, it is acknowledged that a bond between the silicone component and the further polymer component via bonding bodies bonding the components is possible. The further polymer component can include a polyolefin. A bonding effect of these mechanically-bonding bonding bodies is based not substantially on adhesion, but rather on form-fitting contributions, and is based in particular on mechanical anchoring or interlocking. As a result, a secure bond between the silicone component and the at least one further polymer component can be obtained, without the need for secondary bonding forces, such as dipole-dipole forces or hydrogen bridges. The bonding bodies can come into direct mechanical contact with the at least one silicone component on one hand, and with the at least one further polymer component on the other hand. Alternatively, it is possible for at least some or all of the bonding bodies to be fully enclosed by one of the components of the multi-component plastic body, wherein a mechanical bonding of the two components via a form-fit contribution between the bonding bodies encased by the one component and the other component is obtained in the boundary area between the two components, due to the shape of the bonding bodies. A mechanical bonding as set forth in the invention is achieved, in particular when a form-fitting contribution, which provides a cohesion between the components of the multi-component plastic body, is obtained due to undercuts in the bonding body. An undesired delamination is effectively prevented. The sphere of materials for the further polymer component, which is specifically not a silicone component, is thus significantly expanded, specifically to nonpolar polymers. Entirely new classes of plastic material are thus available for bonding with a silicone component. The multi-component plastic body can be used in medical technology or in pharmaceutics. The multi-component plastic body can be a multi-layered tube. The multi-component plastic body can be constructed from two components, three components, four components, or an even greater number of components. The mechanical bonding enables a relative residual mobility of the two components bonded to one another via the bonding agent, which is advantageous for certain applications, e.g. when the multi-component plastic body is used as a pump tube. The multi-component plastic body can be used as a component with a sealing element or as a valve component. A silicone sealing element can be sprayed directly onto an encompassing further polymer component thereby. The further polymer component can be optimized with regard to certain requirements, which are not available when only a silicone material is used, e.g. with regard to hydrophobic properties or gas permeability. The bonding bodies may be made of zinc oxide (ZnO). The bonding bodies may exhibit a typical size in the range of 1 μm to 100 μm, in particular in the range between 10 μm and 40 μm.

The silicone component may be used where biocompatibility is a concern, e.g. in a fluid guidance, or where the multi-component plastic body comes in contact with tissue. The component made from the further polymer can be selected with regard to its function for fulfilling other requirements, e.g. in order to reinforce the multi-component plastic body. The further polymer component can be used, for example, for a targeted coloring of the multi-component plastic body. The further polymer component can also form a function barrier, e.g. a gas barrier.

The multi-component plastic body can also be designed such that desired mechanical properties of the silicone component are used, while an undesired interaction of the silicone component with a contact medium, e.g. a medicine, is prevented, in that this medium only comes in contact with the further polymer component.

The multi-layered tube design allows for multiple application possibilities, e.g. as a catheter tube or a fluid conducting tube. The silicone tube layer can be an inner tube layer and/or an outer tube layer of the multi-layered tube. An outer tube layer of the multi-layered tube can be formed by UV cross-linked silicone. A thermal cross-linking of such a tube layer is then not necessary. This prevents an undesired degradation of other tube layers. The polymer tube layer made of the further polymer can be functionalized prior to the application of an outer silicone layer, e.g. through a corona or plasma treatment. As a result, a cohesion of the outer silicone tube layer can be improved.

The multi-layered tube can be designed according to claim 2 as a two-layered tube. Alternatively, the multi-layered tube can be designed as a three-layered tube or a four-layered tube. An even greater number of tube layers is also possible. If more than two tube layers are used, the bonding agent may be present exclusively between two of these tube layers. Alternatively, more bonding agent layers may be present, in each case between two tube layers of such a multi-layered tube having more than two tube layers.

Material selections in accordance with claims 3 and 4 have proven to be particularly advantageous, depending on the use. The further polymer component can be a polycarbonate (PC) or a polysulfone (PSU).

Another object of the invention is to provide a production method for such a multi-component plastic body.

This object is achieved according to the invention by a method having the features given in claim 5.

The advantages of the method according to the invention correspond to those that have already been explained above with reference to the multi-component plastic body according to the invention. The method can be automated for mass production.

A method according to claim 6 enables a uniform and defined application of the bonding bodies to the base component. A method of this type can also be automated for mass production.

A silicone liquid according to claim 7 is particularly suitable for a dispersion of the bonding bodies. This production method, in which silicone liquid is used, can also be used for the production of a multi-component plastic body, which does not have a thermoplastic elastomer as the further polymer component.

A silication according to claim 8 results in a particularly good bonding of the bonding bodies. This production method, including the silication, can also be used for the production of a multi-component plastic body, which does not have a thermoplastic elastomer as the further polymer component.

A heating according to claim 9 enables a better anchoring of the bonding bodies.

An extrusion according to claim 10 or 11 allows for a particularly inexpensive production of the multi-component plastic body. Alternatively to an extrusion, at least one of the components of the multi-component plastic body can be produced through injection molding. The entire multi-component plastic body can also be produced through appropriate two- or multi-component injection molding.

### BRIEF DESCRIPTION OF THE DRAWINGS

Exemplary embodiments of the invention shall be explained in greater detail below, based on the drawings. Therein:

FIG. 1 shows, schematically, a multi-component plastic body having a silicone layer and a polymer layer made of a further nonpolar polymer, and a bonding agent between these two layers;

FIG. 2 shows a sectional enlargement II from FIG. 1, showing the details of the bonding agent that mechanically bonds the two layers;

FIGS. 3 to 6 show, schematically, cross sections of a layer construction for various designs of multi-component plastic bodies, each of which are designed as multi-layered tubes;

FIG. 7 shows a side view of a filling needle for use in a tube set for transferring a medium, in particular a flowable pharmaceutical product;

FIG. 8 shows a cross section in accordance with line VIII-VIII in FIG. 7; and

FIGS. 9 to 11 show designs of the filling needle according to FIG. 7, having various variations of a liquid-tight connection of a connector side of the filling needle with various designs of a connector component for a filling device of the tube set.

### DETAILED DESCRIPTION OF THE PREFERRED EMBODIMENTS

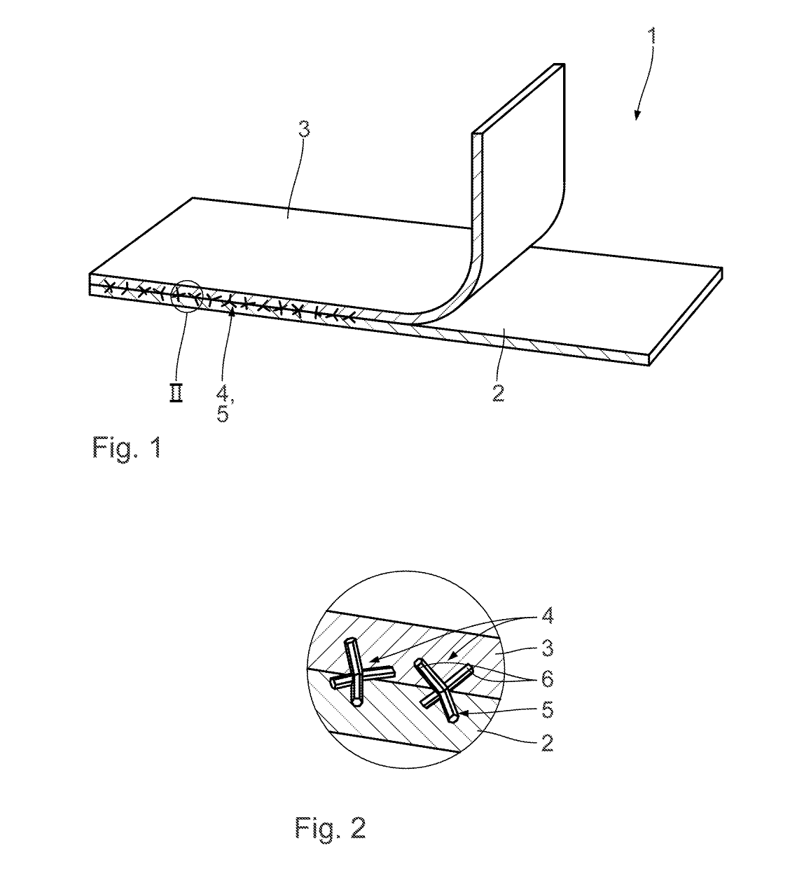

FIG. 1 shows a design of a multi-component plastic body 1, by way of example, a two-layered plastic body. The plastic body 1 has a silicone component in the form of a silicone layer 2, and a further polymer component in the form of a polymer layer 3. This further polymer layer 3 is made of a nonpolar polymer. The further polymer layer 3 is not made of silicone. The further polymer of the polymer layer 3 can be a polyethylene or polypropylene, in particular a low density polyethylene (LDPE). The further polymer component 3 can be made of a thermoplastic, in particular a thermoplastic elastomer. The further polymer can be a nonpolar polyolefin.

Examples of nonpolar polymers are polyethylene (PE), polypropylene (PP), polystyrene (PS), or polytetrafluoroethylene (PTFE). Examples of less polar polymers, which are likewise to be understood to be nonpolar polymers as set forth in this application, are copolymers made of ethylene and unsaturated esters (e.g. EVAC) or polyphenylene ether (PPE).

The multi-component plastic body 1 can be used in medical or pharmaceutical practices.

A bonding agent 4 is disposed between the silicone component 2 and the further polymer component 3. The bonding agent 4 includes the bonding bodies 5 mechanically bonding the two components 2, 3, i.e. the two layers. The bonding bodies 5 are made of zinc oxide (ZnO). The bonding bodies 5 have the shape of tetrapods. The ZnO tetrapods have a typical size in the range of 1 μm to 100 μm, in particular in the range of 10 μm to 40 μm. Free ends 6 of the bonding bodies 5 are anchored in, or interlocked to the silicone layer 2 on one side, and to the further polymer layer 3 on the other side. In this manner, a mechanical bond is obtained between the two layers 2, 3, thus between the silicone layer 2 and the further polymer layer 3. This mechanical bond has a form-fitting contribution, i.e. is not substantially based on adhesion. This does not exclude the possibility of an adhesion contribution to this bond.

In the assembly shown in the detail enlargement of FIG. 2, the bonding bodies 5 are in direct contact with the silicone layer 2 on one hand, and the further polymer layer 3 on the other hand. Alternatively, it is possible that likewise, some or all of the bonding bodies 5 are fully encased by one of the two components, i.e. either the silicone layer 2 or the further polymer layer 3, wherein a mechanical bonding between the two layers 2, 3 still results from a form-fitting contribution, generated via the shape of the bonding body, in particular via at least one undercut. By way of example, the bonding bodies 5 can be covered with the silicone material of the silicone layer 2 in the region of an end 6 or numerous ends 6, which protrude into the polymer layer 3.

To manufacture the multi-component plastic body 1, first a base component is produced, which is either the silicone component 2 or the further polymer component 3. Subsequently, the bonding agent 4 is applied to this base component 2 or 3. Lastly, a cover component, which can be either the further polymer component or the silicone component, is applied to the base component, such that the bonding agent 4 ends up lying between the silicone component 2 and the further polymer component 3.

Prior to the application of the bonding agent 4 to the base component, the bonding bodies 5 of the bonding agent 4 can be dispersed in a liquid, in particular a silicone liquid. Subsequently, the dispersed bonding bodies 5 can be applied to the base component, before the cover component is applied.

Prior to the application of the bonding agent 4, a silication of a surface of the base component facing the bonding agent 4, i.e. the silicone component 2, for example, may take place.

After applying the cover component, a heating of the raw multi-component plastic body generated in this manner can occur, by means of which, in particular, the bonding body 5 is better anchored in the layers 2, 3. After heating this raw multi-component plastic body, and subsequent cooling thereof, the finished multi-component plastic body 1 is obtained.

The silicone component 2, or the further polymer component 3 can be produced by injection molding.

Insofar as the multi-component plastic body is a multi-layered tube, as shall be explained below, the silicone and polymer components can also be produced or applied through extrusion.

For the application of a bonding agent dispersion, the respective prepared inner tube layer can be drawn through the bonding agent dispersion.

An encasing of the inner tube layer coated with the bonding agent can be obtained using a cross extruder head.

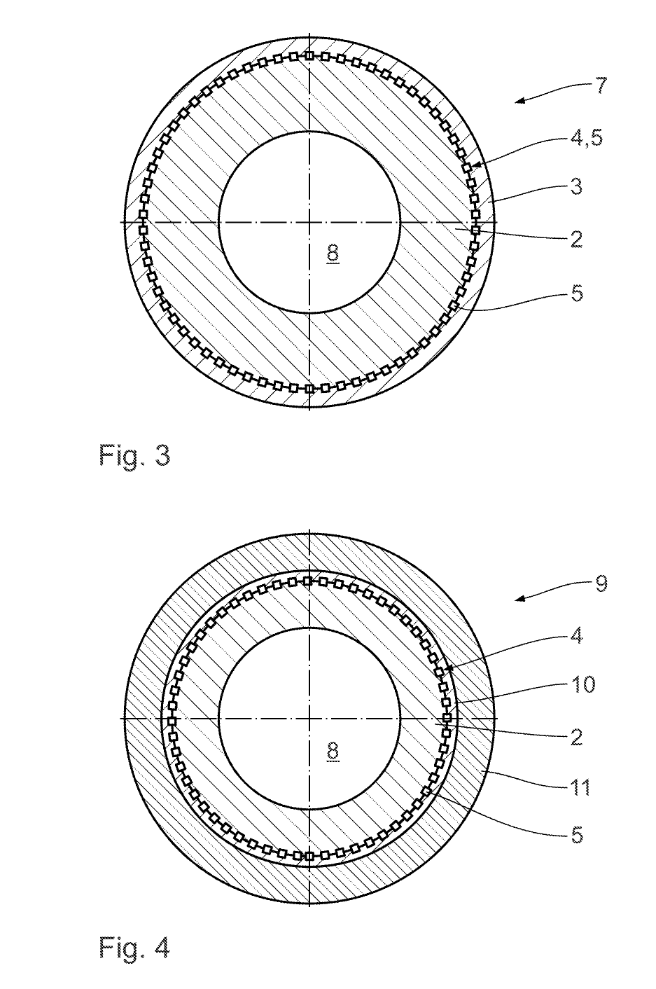

FIG. 3 shows a multi-component plastic body designed as a multi-layered tube 7. The silicone component 2 forms a silicone tube layer thereby, and the further polymer component 3 forms a polymer tube layer. In the design according to FIG. 3, the silicone tube layer 2 is an inner tube layer of the multi-layered tube 7, which delimits a lumen 8 of the multi-layered tube 7. The silicone tube layer 3 has a hardness of Shore 60 A.

The silicone material of the silicone tube layer 3 can be a platinum cross-linked or a peroxide cross-linked silicone.

The polymer tube layer 3 of the multi-layered tube 7 made of the additional, nonpolar polymer, is an outer tube layer enclosing the silicone tube layer 2. The bonding agent 4 having the tetrapod bonding bodies 5 is disposed, in turn, between the two tube layers 2, 3 of the multi-layer tube 7. The layer thickness of the inner silicone tube layer 2 is greater than that of the outer polymer tube layer 3.

The multi-layered tube 7 can be used as a pharmaceutical transferring tube. The further polymer tube layer 3 of the multi-layered tube 7 can be colored. The outer polymer tube layer 3 can be completely opaque, or it can be colored with a dye that absorbs light in the UV range. The multi-layered tube 7 can be translucent on the whole, such that a visual checking of the lumen 8 remains possible.

The inner silicone tube layer 2 can be formed by a platinum cross-linking silicone rubber. The inner silicone tube layer 2 can have a silicated surface.

Based on FIG. 4, another design of a multi-layered tube 9 shall be explained below. Components and functions corresponding to those already explained above in reference to FIGS. 1 to 3 exhibit the same reference numerals and names, and shall not be discussed again in detail.

The multi-layered tube 9 comprises an innermost silicone layer 2, which is surrounded by an intermediate tube layer 10 made of a further polymer. The intermediate tube layer 10 represents the further polymer component of the multi-layered tube 9. The bonding agent 4 having the bonding bodies 5 is disposed between the intermediate tube layer 10 and the innermost silicone tube layer 2. The intermediate tube layer 10 is encased in an outer tube layer 11, which is designed in turn as a silicone tube layer. The outer silicone tube layer 11 is a tube layer made of UV cross-linked silicone. A thermal cross-linking step for the outer silicone tube layer 11 is no longer necessary thereby. Prior to the application of the outer silicone tube layer 11, the intermediate tube layer 10 can be functionalized in the production of the multi-layered tube 9 in order to improve the bonding of the outer silicone tube layer 11. This functionalization of the intermediate tube layer 10 can be obtained by means of a corona or plasma treatment. The intermediate tube layer 10 has a layer thickness that is thinner than the layer thicknesses of the silicone tube layers 2 and 11 of the multi-layered tube 9.

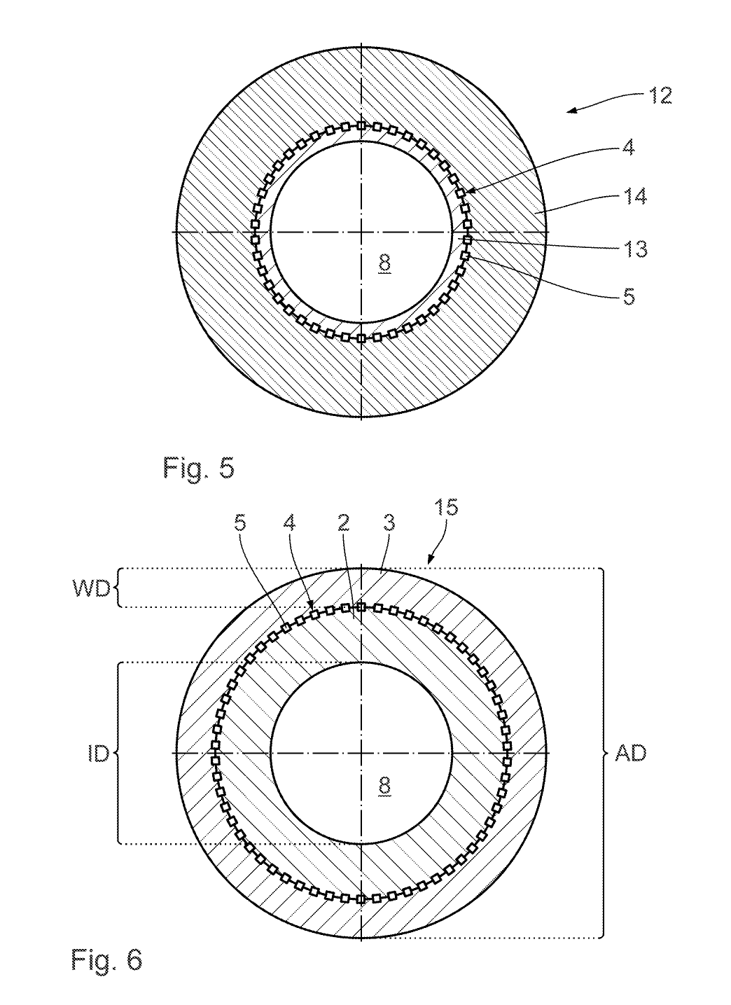

Based on FIG. 5, another design of a multi-layered tube 12 shall be explained below. Components and functions corresponding to those that have already been explained above in reference to FIGS. 1 to 4, exhibit the same reference numerals and names, and shall not be discussed again in detail.

In the multi-component tube 12, an innermost tube layer 13 is designed as the further polymer component. This is surrounded by bonding agent 4 having the bonding bodies 5, and furthermore by an outer tube layer 14, which represents the silicone component of the multi-layered tube 12. The outer silicone tube layer 14 is also a layer made of UV cross-linked silicone. The layer thickness of the inner polymer tube layer 13 is thinner than that of the outer silicone tube layer 14.

With an extrusion of the multi-layered tubes 7, 9, 12, the innermost tube layer 2, 13 is extruded first, and subsequently a bonding agent dispersion having the bonding bodies 5 is applied thereto, upon which the other tube layer 3, 14 or the intermediate tube layer 11 is applied by means of extrusion. In the three-layered tube 9 according to FIG. 4, the outer silicone tube layer 11 is subsequently applied thereto.

The multi-layered tubes 9 and 12 can be used, for example, as odor-tight rectal catheters.

Due to the fact that the polymer tube layer 10, or 13, respectively, of the multi-layered tubes 9 or 12, is thinner than the silicone tube layers 3, 11 or 14, respectively, the respective multi-layered tube 9, 12 displays good flexibility properties.

The multi-layered tubes 9 and 12 are translucent on the whole. A visual checking of the lumen 8 is possible from the exterior.

The multi-layered tubes 9 and 12 can also be used as pump tubes, in particular for a peristaltic pump.

FIG. 6 shows another design of a multi-layered tube 15. Components and functions corresponding to those that have already been explained above in reference to FIGS. 1 to 5, exhibit the same reference numerals and names, and shall not be discussed again in detail.

The multi-layered tube 15 corresponds in its fundamental construction to the multi-layered tube 7 according to FIG. 3. Differences consist primarily in the diameter relationships. The multi-layered tube 15 has an outer diameter AD of 5 mm. An inner diameter ID is 1.2 mm. The wall thickness of the outer polymer tube layer WD is 0.7 mm. Accordingly, the wall thickness of the inner silicone tube layer 2 is 1.2 mm.

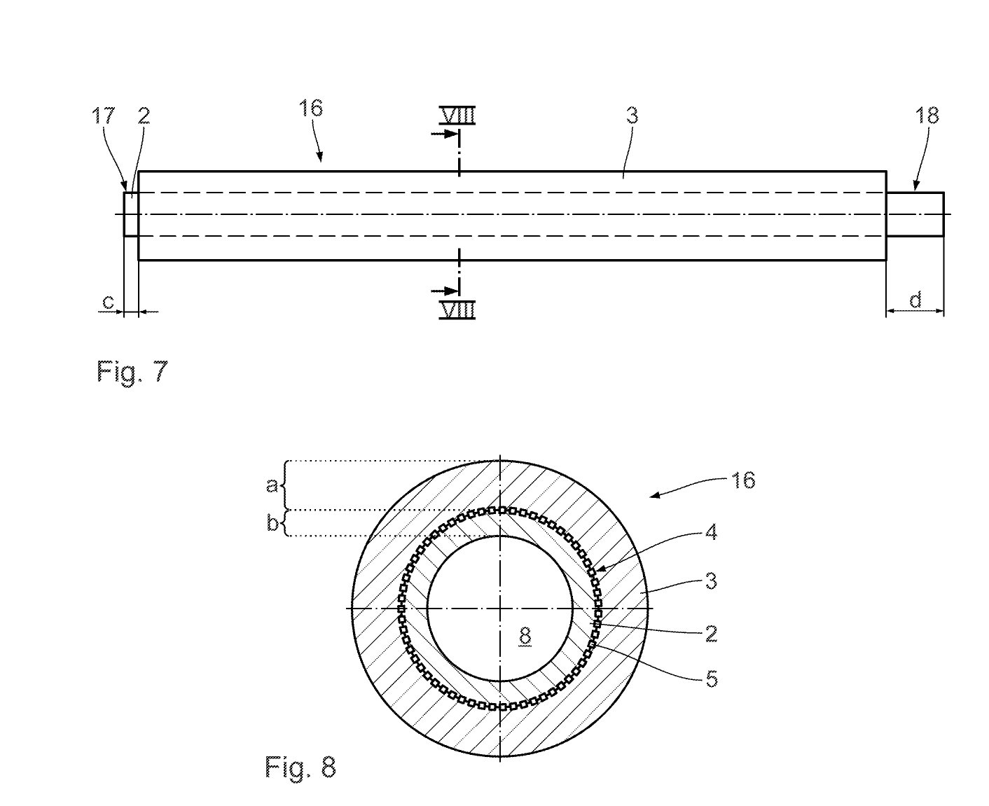

Another design of a multi-component plastic body in the form of a filling needle shall be explained below based on FIGS. 7 to 11. Components and functions corresponding to those that have already been explained above in reference to FIGS. 1 to 6, exhibit the same reference numerals and names, and shall not be discussed again in detail.

The filling needle 16 can be used in a tube set for transferring a flowable pharmaceutical product. A tube set of this type is fundamentally known from WO 2008/103 484 A2.

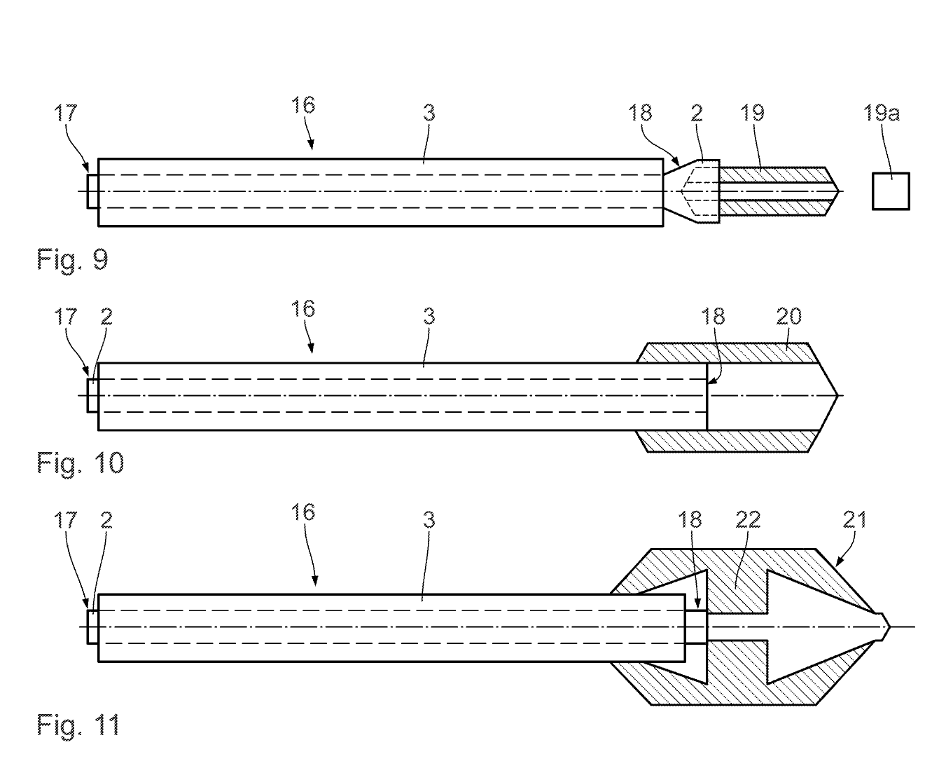

The filling needle 16 has a needle end 17, on the left in FIG. 7, for temporary insertion into a filling vessel. Furthermore, the filling needle 16 has a connector end lying opposite the needle end 17, on the right in FIG. 7, for connecting the filling needle 16 to a filling device (cf. FIG. 9), via which the pharmaceutical product can be supplied to the filling needle 16. The filling device is a component of the tube set. Neither the filling vessel nor the filling device are depicted in FIG. 7.

The filling needle 16 has an inner silicone tube layer 2 that defines an inner tube lumen 8. The tube layer sequence of the filling needle 16 corresponds in terms of its fundamental construction to that of the multi-layered tubes 7 and 15 explained above. The bonding agent 4 having the bonding bodies 5 is disposed in turn between the inner silicone tube layer 2 and the outer further polymer tube layer 3. Differences between the layer construction of the filling needle 16 and that of the multi-layered tubes 7 and 15 occur in turn in the layer thicknesses of the two tube layers 2, 3. A layer thickness a of the outer, further polymer tube layer 3 is greater than 0.7 mm. This layer thickness is greater or equal to a layer thickness b of the inner silicone tube layer 2.

The outer, further polymer tube layer 3 serves as a reinforcing tube layer. The outer tube layer 3 can be made of polypropylene.

The inner silicone tube layer 2 extends beyond the reinforcing tube layer 3 along an excess c at the needle end 17. The excess c is in the range of 1 mm to 5 mm.

The inner tube layer 2 extends beyond the outer reinforcing tube layer 3 along an excess d at the connector end 18. The excess d can be greater than the excess c.

FIGS. 9 to 11 show various designs of the connector components for connecting the filling needle 16 to the filling device of the tube set. This filling device is schematically depicted in FIG. 9, indicated by the numeral 19a.

In the design according to FIG. 9, the connector component is designed as a filling tube 19, which connects the filling needle 16 to the filling device 19a of the tube set. The filling tube 19 is a silicone tube. The inner silicone tube layer 2 of the filling needle 16 is slid over the filling tube 19. The inner silicone tube layer 2 of the filling needle is thus widened in the region of the connector end 18, and placed over an outer circumference of the filling tube 19, such that the filling tube 19 is partially slid into the silicone tube layer 2 of the filling needle 16 at the connector end 18.

In the design according to FIG. 10, the connector component is likewise designed as a filling tube 20 between the filling needle 16 and the filling device of the tube set. The filling tube 20 has a significantly larger inner diameter than the filling tube 19 of the design according to FIG. 9. This inner diameter of the filling tube 20 is sized such that the filling tube 20 can be tightly slid onto the outer wall of the filling needle 16. In this case, an excess of the inner silicone tube layer 2 of the filling needle, extending over the reinforcing tube layer 3 at the connector end 18 is not necessary, as is depicted in FIG. 10.

In the design according to FIG. 11, a silicone connector 21 is used, as is known fundamentally from DE 10 2011 076 938 A1.

Alternatively to the design according to FIG. 10, the connector end 18 can also be inserted into an exposed inner silicone tube layer 2 in a filling tube designed in the manner of the filling tube 20, the diameter of which has been adapted accordingly, having a correspondingly large excess region d, which is not depicted in the drawings. An inner diameter of this variation of the filling tube 20 then corresponds to an outer diameter of the inner silicone tube layer 2.

The inner silicone tube layer 2 can adjoin an inner stop element 22 of the connector 21 in a sealing manner in the assembly according to FIG. 11, such that a liquid-tight connection of the inner silicone tube layer 2 to the connector 21 is obtained.

Through corresponding designs of the connection, which are described above in reference to FIGS. 9 to 11, it is possible to make all of the fluid channel surfaces of the tube layer from the filling vessel to the needle end 17 out of silicone or silicone rubber.

In a design of the filling needle 16 that is not depicted, a chemical bonding agent is used. In this case, bonding bodies in the manner of the bonding bodies 5 can also be omitted. Alternatively, it is possible to obtain a bonding between the two layers 2 and 3 via a combination of bonding bodies in the manner of the bonding bodies 5, and a chemical bonding component.

1. A multi-component plastic body comprising:
at least one silicone component;
at least one further polymer component made of a further nonpolar polymer, wherein the further polymer component has at least one thermoplastic elastomer;
a bonding agent between the at least one silicone component and the at least one further polymer component;
wherein the bonding agent has bonding bodies, which mechanically bond the two components; and
wherein the multi-component plastic body is a multi-layered tube, wherein the silicone component forms a silicone tube layer, and the polymer component forms a polymer tube layer.

2. The multi-component plastic body according to claim 1, wherein the multi-layered tube is a two-layered tube.

3. The multi-component plastic body according to claim 1, wherein the at least one further polymer component includes at least one thermoplastic.

4. The multi-component plastic body according to claim 3, wherein the at least one further polymer component includes polypropylene.

5. A method for the production of a multi-component plastic body comprising the following steps:
(a) production of a base component, which is either a silicone component or a further polymer component;
(b) application of a bonding agent to the base component; and
(c) application of a cover component, which is either the further polymer component or the silicone component, to the base component, such that the bonding agent comes to lie between the silicone component and the further polymer component.

6. The method according to claim 5, further comprising the step of dispersion of bonding bodies of the bonding agent in a liquid prior to application of the bonding agent to the base component, and wherein the dispersed bonding bodies are applied onto the produced base component prior to the application of the cover component.

7. The method according to claim 6, wherein the liquid is a silicone liquid.

8. The method according to claim 7, comprising the further step if silication of a surface of the base component facing toward the bonding agent prior to the application of the bonding agent.

9. The method according to claim 5, comprising the further step of heating the raw multi-component plastic body after application of the cover component.

10. The method according to claim 5, wherein the base component is produced through extrusion.

11. The method according to claim 10, wherein the cover component is produced through extrusion.

12. The method according to claim 5, wherein the one of the base component and the cover component that is made of the further polymer component is comprised of a nonpolar polymer.

13. The method according to claim 12, wherein the base component and the cover component are elongate and tubular.

14. The method according to claim 13, wherein the base component and the cover component are generally cylindrical.

15. The method according to claim 14, wherein the base component and the cover component form a two-layered tube.

16. The method according to claim 13, wherein the further polymer is comprised of a thermoplastic.

17. The method according to claim 16, wherein the further polymer is comprised of one of polyethylene, polypropylene, polystyrene, polytetrafluoroethylene, an ethylene copolymer, an unsaturated ester copolymer, and a polyphenylene ether copolymer.

18. The multi-component plastic body according to claim 1, wherein the bonding agent comprises a silicone liquid in which the bonding bodies are carried.

19. The multi-component plastic body according to claim 18, wherein a surface of the base component onto which the bonding agent is applied comprises a silication surface.

20. The multi-component plastic body according to claim 1, wherein the at least one further polymer component is comprised of one of polyethylene, polypropylene, polystyrene, polytetrafluoroethylene, an ethylene copolymer, an unsaturated ester copolymer, and a polyphenylene ether copolymer.
